(19) United States
(12) Patent Application Publication
(10) Pub. No.: US 2026/0336201 A1
(43) Pub. Date: Oct. 29, 2026

(54) SYSTEM AND METHODS FOR TOMOGRAPHIC VAT PHOTOPOLYMERIZATION

(71) Applicant: Danmarks Tekniske Universitet, Kongens Lyngby (DK)

(72) Inventor: Yi Yang, Kongens Lyngby (DK)

(73) Assignee: Danmarks Tekniske Universitet, Kongens Lyngby (DK)

(21) Appl. No.: 19/114,551

(22) PCT Filed: Sep. 27, 2023
(86) PCT No.: PCT/EP2023/076628

§ 371 Date: Mar. 24, 2025

(30) Foreign Application Priority Data
Sep. 27, 2022 (EP) 22198117.8

(51) Int. Cl. B29C 64/129; B29C 64/282; B29C 64/393; B29K 33/00; B29K 105/00; B33Y 10/00; B33Y 30/00; B33Y 50/02

(52) U.S. Cl. CPC B29C 64/129; B29C 64/282; B29C 64/393; B29K 2033/12; B29K 2105/0002; B29K 2105/0044; B33Y 10/00; B33Y 30/00; B33Y 50/02

(57) ABSTRACT

The invention regards an a method of fabricating a three-dimensional object by tomographic vat photopolymerization comprising computing a number of primary projections describing the three-dimensional object; and wherein the primary projections comprise positive and negative intensity values; deriving, from each primary projection, a positive and a negative projection, corresponding to the positive and negative intensity values respectively; providing a build volume (24) comprising: a monomer; a precursor of a stable radical scavenger inducible by light of a first wavelength and wherein said stable radical scavenger is sensitive to light of a second wavelength; and a photosensitive component capable of initiating polymerization of the monomer by light of the second wavelength; and irradiating the build volume at the respective corresponding orientations with light of the first wavelength in a first series of patterns of light; and light of the second wavelength in a second series of patterns of light.

### CROSS-REFERENCE TO RELATED APPLICATIONS

The present application is the National Phase entry of International Patent Application No. PCT/EP2023/076628, filed Sep. 27, 2023, which claims priority to European Patent Application No. 22198117.8, filed Sep. 27, 2022, the entire contents of both are hereby incorporated by reference into this application.

### TECHNICAL FIELD

The present disclosure relates to a system for tomographic vat photopolymerization and a method of using the system.

### BACKGROUND

Additive manufacturing (AM) is a technique for fabricating a wide range of structures and complex geometries based on three-dimensional model data. The process relies on the printing of successive layers of materials on top of each other. The technology was originally developed in a process known as stereolithography (SLA).

SLA typically uses UV light to initiate a chain reaction on a layer of resin or monomer solution, for example acrylic or epoxy-based. The monomers are UV-active and convert to polymer chains after activation (radicalization). The polymerization leads to the generation of a pattern inside the resin layer that is solidified, and that can hold the subsequent layers. Following printing, the unreacted resin is removed. Additionally, depending on the material and the desired mechanical properties, post-process treatments such as heating or photo-curing may be applied to the printed object.

While SLA is a versatile method that has gained widespread use, mainly attributing to its success in rapid and cheap prototyping, it suffers from slow printing speeds. This is a property that is inherent to SLA, as it is a layer-by-layer processing method. Once a layer is irradiated and cured, a new layer of uncured material must be provided above or below the solid layer, depending on the build direction. Most commonly, the uncured material is provided by mechanically recoating the surface which, in addition to increasing the printing time, may act to distort the formed parts.

Another, more recent, technology is tomographic vat photopolymerization wherein a build volume comprising photosensitive components is illuminated from multiple angles in order to rapidly produce complex materials. The technology thus relies on a completely different approach as compared to layer-by-layer technologies, as it physically reverses the principle of computed tomography (CT) to realize high-speed, auxiliary-free 3D printing.

WO2018/208378 discloses a method of forming an object comprising providing a volume of photo-curable resin contained within an optically transparent resin container, and simultaneously directing optical projections from a plurality of angles about a z axis extending through the volume of photo-curable resin. The projections act over a fixed temporal exposure period, during which the net exposure dose is sufficient to cure select portions of the volume of photo-curable resin, and to leave other portions uncured.

WO 2021/116501 A1 discloses a conventional layer-by-layer method for volumetric microlithography wherein individual planes of a build volume is exposed and polymerized sequentially.

Tomographic vat photopolymerization is still in its infancy and has great prospects for the future. However, a significant drawback is the limited print accuracy attainable in combination with a typical short timespan at which a maximal print accuracy is achieved Thus, there exists a need for improving the printing accuracy of tomographic vat polymerization, and the timespan during which a high printing accuracy is obtained.

### SUMMARY

The present inventors have realized that while the technological field of tomographic vat polymerization tomographic vat polymerization has built upon knowledge gained from computed tomography (CT), in that tomographic vat polymerization physically reverses the principle of CT, tomographic vat polymerization is limited by a non-negativity constraint.

While CT relies on techniques that produce also negative values in a sinogram to improve the quality of geometric reconstruction, light sources in tomographic vat polymerization cannot deliver negative illumination. As a result, tomographic vat polymerization suffers from a limited print accuracy.

In order to overcome the non-negativity constraint associated with tomographic vat polymerization, the present inventors have further realized that sinograms comprising negative values may be used for tomographic vat photopolymerization by relying on a combination of a plurality of wavelengths, wherein at least one first wavelength is associated with induction of a stable radical scavenger, and at least one second wavelength is associated with initiation of polymerization of a monomer, wherein the stable radical scavenger is sensitive to at least one of the second wavelength(s).

Thus, in a first aspect, the present disclosure relates to a method of fabricating a three-dimensional object, such as by tomographic vat photopolymerization, the method comprising the steps of:
computing a number of primary projections describing the three-dimensional object to be formed from different orientation angles of said object; and
wherein the primary projections comprise positive and negative intensity values;
deriving, from each primary projection, a positive projection, corresponding to the positive intensity values, and a negative projection, corresponding to the negative intensity values;
providing a build volume comprising:
   a monomer;
   a precursor of a stable radical scavenger; wherein the stable radical scavenger is inducible by light of a first wavelength and wherein said stable radical scavenger is sensitive to light of a second wavelength, such as wherein the stable radical scavenger is arranged to suppress and/or prevent polymerization of the monomer by being sensitive to light of a second wavelength;
   a photosensitive component capable of initiating polymerization of the monomer upon receiving light of the second wavelength; and
irradiating the build volume at the different orientation angles, such as to create a 3D energy distribution, with:
   light of the first wavelength in a first series of patterns of light as defined by the negative projections; and
   light of the second wavelength in a second series of patterns of light as defined by the positive projections.

Thus, the light of the first wavelength may result in a first 3D energy distribution, while the light of the second wavelength may result in a second 3D energy distribution. Thus, the fabrication of the three-dimensional object relies on the generation of a first energy distribution of light that suppresses and/or prevents polymerization, and a second energy distribution of light that activates the photosensitive component.

The stable radical scavenger may be arranged such that it absorbs light of the second wavelength. Furthermore, the polymerization of voxels can be suppressed and/or prevented by irradiating said voxels with light of the first wavelength.

The method may be arranged such that the focal length is set such that the focal plane intersects the center of the build volume. Thus, the presently disclosed method may differ from other additive manufacturing methods relying on varying the focal length. Further, the presently disclosed method is typically arranged such that the irradiation is provided from multiple angles with respect to the build volume, for example by rotating the build volume around the center of the build volume, which may correspond to the focal plane of the irradiation. Alternatively, or additionally, the irradiation source may be arranged such that it rotates around the build volume.

Advantageously, the method allows for controllable stability for each voxel of the build volume individually and can be utilized to remove the non-negativity constraint for tomographic vat polymerization, thus the method may allow for an increased print accuracy, expanded processing window, increased printing speed and enhanced property modulation via grayscale printing, and can further be used to manufacture more complex shapes not previously possible.

A voxel (volumetric picture element), as used herein, refers to a volume element, typically a cube, representing a value on a regular grid in a three dimensional space.

The build volume is divided into a number of voxels, that each is either a liquid voxel, which is, as used here, a voxel that is to remain liquid in order to accurately reproduce the three-dimensional object. Alternatively, the voxel may be a solid voxel, which is, as used herein, a voxel that is to become solid (e.g. polymerized) in order to accurately reproduce the three-dimensional object.

Thus, the voxels can be said to be a 3D binary grid array, wherein each voxel has a binary value of either being liquid or solid, as defined by the three-dimensional object to be reproduced.

The size of the voxel influences the accuracy of the manufacturing of the three-dimensional object. The voxel size is typically determined by the printing resolution. Smaller voxels (i.e. a higher printing resolution) typically allow for a higher degree of details being reproduced, and a higher printing accuracy.

The primary projections describe the three-dimensional object to be formed from different orientation angles of said object, and is used to derive the positive projections and the negative projections.

The irradiation of the build volume induces a polymerization of the polymerizing voxels while suppressing polymerization of unpolymerizing voxels. This is advantageously achieved by irradiating the build volume at the different orientation angles with primary projections, such that light of the first wavelength in a first series of patterns of light is defined by the negative projections; and light of the second wavelength in a second series of patterns of light is defined by the positive projections.

Typically, the energy deposited in the first series of patterns of light acts to induce the stable radical scavenger and thus prevent polymerization of the voxels receiving said energy. On the other hand, the energy deposited in the second series of patterns of lights typically acts to induce polymerization of the voxels receiving said energy, by activation of the photosensitive component and/or by acting to deplete the stable radical scavenger of said voxels.

Preferably, the build volume is illuminated, typically simultaneously, at the respective corresponding orientations, with:
light of the first wavelength in the first series of patterns of light, as defined by the negative projections; and
light of the second wavelength in the second series of patterns of light, as defined by the positive projections.

The precursor of the stable radical scavenger may vary depending on the polymerization system used, with various chain-growth polymerization methods being known. Preferably, the precursor of the stable radical scavenger is selected such that the stable scavenger is a species that i) can be generated via external stimulus (e.g., UV illumination), ii) absorbs the incident light having second wavelength, iii) has a long lifespan, and/or iv) inhibits polymerization.

Preferably, the stable radical scavenger is arranged such that it is generated from, or by, the precursor of the stable radical scavenger upon induction by light of the first wavelength. Once the stable radical scavenger is generated, it is preferably arranged to inhibit polymerization by absorbing light of the second wavelength. In this way, light can be prevented from activating the photosensitive component from initiating polymerization. Typically, the concentration of the stable radical scavenger may be decreased by the provision of light of the second wavelength. Thus, light of the first wavelength may be used to induce the stable radical scavenger from the precursor, while light of the second wavelength may be used to remove the stable radical scavenger.

In this way, the rate of polymerization may be controlled by controlling the relative energy dose between the first and the second wavelength provided to each voxel of the build volume. In this way, also the print accuracy can be increased, the processing window can be expanded and the overall printing speed can be increased.

Typically, the primary projections are one or more sinograms comprising positive and negative values. It is further a preference that the one or more primary projections are divided into one or more positive projections and one or more negative projections. Preferably, such that all negative pixel values form part of the one or more negative projections and that all positive pixel values form part of the one or more positive projections. Most preferably, such that summarizing the positive and negative projection, on a pixel-by-pixel basis, results in the primary projection.

The negative intensity values are typically thus the pixels of the negative projections that provide a negative value to the build volume, in order to correctly reproduce the three dimensional object. As negative intensity values cannot be illuminated onto the build volume, the resulting energy distribution of the illumination of the negative patterns by light of the first wavelength are instead used to form a negative illumination effect, as the light of the first wavelength may result in an induction of the stable radical scavenger. In this way, methods used in computed tomography may be directly applied to tomographic vat photopolymerization, e.g. the sinogram calculations.

In a second aspect, the present disclosure relates to a system for fabricating a three-dimensional object from a build volume, the system comprising:
a processing unit configured for
   computing a number of primary projections describing the multi-material three-dimensional object to be formed from different orientation angles of said object; and wherein the primary projections comprise positive and negative intensity values;
   deriving, from each primary projection, a positive projection, corresponding to the positive intensity values, and a negative projection, corresponding to the negative intensity values;
a projection system configured for:
   irradiating the build volume at the different orientation angles with:
      light of a first wavelength in a first series of patterns of light as defined by the negative projections; and
      light of a second wavelength in a second series of patterns of light as defined by the positive projections.

The system is preferably arranged to carry out the method of fabricating a three-dimensional object as disclosed elsewhere herein. The system may for example be arranged to carry out a method of fabricating a three-dimensional object by tomographic vat photopolymerization. The system may for example be arranged such that it irradiates a build volume with a series of projections, e.g. primary projections, at different orientation angles, with a constant focal length. The focal length may for example be set such that the focal plane intersects the center of the build volume.

The system is typically arranged to fabricate a three-dimensional object based on a build volume. In specific embodiments the build volume may form part of the system. In such embodiments, the system may comprise a build volume comprising:
a monomer;
a precursor of a stable radical scavenger; wherein the stable radical scavenger is inducible by light of the first wavelength and wherein said stable radical scavenger is sensitive to light of the second wavelength; and
a photosensitive component capable of initiating polymerization of the monomer upon receiving light of the second wavelength.

Typically, the system is arranged to irradiate the build volume with light of the first wavelength, in the first series of patterns of light and at the respective corresponding orientations, such that a first energy distribution is provided to the build volume, wherein the energy provided to unpolymerizing (non-polymerizing, i.e. voxels that are to remain unpolymerized in order to accurately reproduce the three dimensional object) voxels is higher than the energy provided to polymerizing voxels; and wherein the polymerizing voxels and the unpolymerizing voxels are voxels of the build volume that are to polymerize or remain unpolymerized in order to accurately reproduce the three-dimensional object.

### BRIEF DESCRIPTION OF THE DRAWINGS

In the following embodiment and examples will be described in greater detail with reference to the accompanying drawings:

FIG. 1 illustrates the change of concentration of radical scavenger species of the build volume during irradiation of the build volume with light of the first wavelength and light of the second wavelength according to a method of fabricating a three-dimensional object as disclosed herein;

FIG. 2 shows a schematic view of an embodiment of a system for dual color tomographic volumetric printing (DC tomographic vat polymerization) as disclosed herein;

FIGS. 3A-C shows a comparison between the generation of a three dimensional object based on single and dual color tomographic vat polymerization, according to an embodiment disclosed herein, at different exposure times;

FIGS. 4A-C shows a square projection pattern, and the corresponding sinogram and histogram;

FIGS. 5A-D shows the impact of non-negativity constraint in conventional tomographic vat photopolymerization, using the sinogram of FIG. 4;

FIGS. 6A-D shows the resulting sinograms and histograms according to an embodiment of the presently disclosed method; and

FIGS. 7A-B shows the generation of a three dimensional object based on an embodiment of the presently disclosed method.

### DETAILED DESCRIPTION

Tomographic volumetric printing (or Computed axial lithography) may be considered as physically reversing the principle of computed tomography (CT) to realize high-speed, auxiliary-free 3D printing. In tomographic vat polymerization, all points in a 3D object are typically cured in parallel, and the printing time can become independent of the number of voxels.

While CT allows for negative values in a sinogram to improve the quality of geometric reconstruction (e.g., filtered back projection), projectors in tomographic vat polymerization cannot deliver negative illumination. Tomographic vat polymerization instead relies on sophisticated algorithms for sinogram computation and settles with a lowered print accuracy.

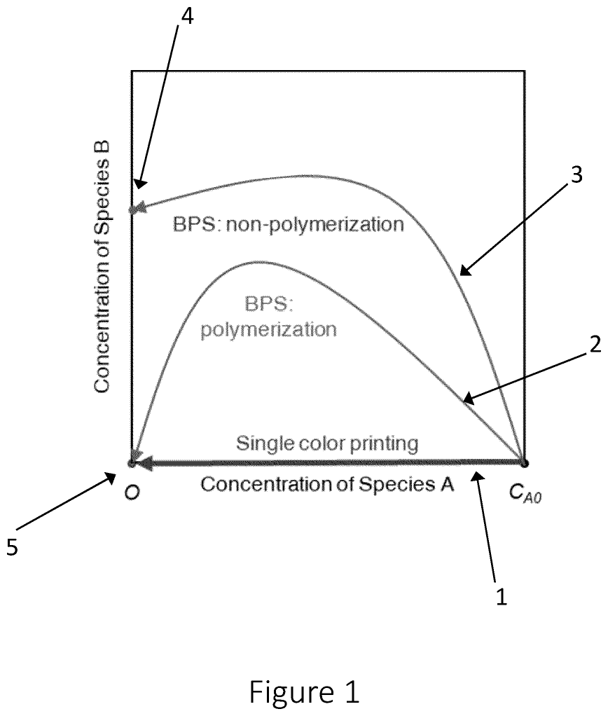

Through the use of a stable radical scavenger, the behavior of the photopolymerizable system may be redefined. Without the stable radical scavenger tomographic vat polymerization operates unidirectionally along the axis of abscissas (FIG. 1). The concentration of the secondary radical scavenger is in such a system zero, i.e. the concentration at each voxel starts at (C_{A0}, 0). Through illumination of e.g. light of the second wavelength, the state of the voxel is pushed towards the origin (0,0), where polymerization occurs. The system for carrying out is typically a single color tomographic vat polymerization system.

FIG. 1 illustrates the change of concentration of a radical scavenger species of the build volume during irradiation of the build volume with light of the first wavelength and light of the second wavelength according to a method of fabricating a three-dimensional object as disclosed herein.

As shown in FIG. 1, in conventional single color tomographic vat polymerization (1), the entire build volume is illuminated from multiple angles, and voxels inevitably receive irradiation meant for the voxels that they shadow. Ultimately, all voxels move towards the origin (5)—the only stationary system for single color tomographic vat polymerization.

If two voxels were adjacent in the build volume and one of said voxels is to be cured but not the other, a dose contrast preferably needs to be formed such that the illumination could be terminated when the dose received by the former surpasses the curing threshold while that received by the latter does not. The time period that meets this requirement is referred to herein as the process window.

Through the use of a system for dual color tomographic vat polymerization in combination with a stable radical scavenger, a binary photoinhibitory system (BPS) may be formed that creates stationary states (SS) with controllable stability for each voxel individually and can be utilized to remove the non-negative constraint (NNC) for tomographic vat polymerization. Thus allowing for negative projections (e.g. sinograms) having negative intensity values, which is typically required in order to accurately reproduce a three-dimensional object.

An ideal BPS typically behaves according to

$$\frac{{dC}_{A}}{dt} = - {k}_{0 , A , vis} ( \frac{{P}_{vis}}{V} ) ( \frac{{C}_{A}}{{C}_{A} + {C}_{B}} ) , \qquad Eq . 1$$

$$\frac{{dC}_{B}}{dt} = - {k}_{1 , B} {C}_{B} + {k}_{0 , B , UV} ( \frac{{P}_{UV}}{V} ) - {k}_{0 , B , vis} ( \frac{{P}_{vis}}{V} ) ( \frac{{C}_{B}}{{C}_{A} + {C}_{B}} ) , \qquad Eq . 2$$

in which C is concentration (mol m⁻³), t is time(s), k₀ and k₁ are zeroth (mol J⁻¹) and first (s⁻¹) order rate constants, P is power of irradiation (mW) and V is voxel volume (m3). Subscripts vis and UV denote the type of irradiation while A and B denote the species that introduce nonlinear photoresponse. Species A may be a secondary radical scavenger that pre-exists in the build volume and is preferably stable without illumination (e.g., oxygen in free radical polymerization). Species B is preferably a stable radical scavenger that i) can be generated via external stimulus (e.g., UV illumination), ii) competes with species A for incident light, iii) has a long lifespan, and iv) inhibits polymerization.

A build volume comprising a stable radical scavenger allows for the creation of a new stationary system on the axis of ordinates (FIG. 1):

$${( {C}_{A} , {C}_{B} )}_{SS} = ( 0 , \frac{{k}_{0 , B , UV}}{{k}_{1 , B}} \frac{{P}_{UV}}{V} - \frac{{k}_{0 , B , vis}}{{k}_{1 , B} {Vk}_{1 , B}} \frac{{P}_{vis}}{V} ) . \qquad Eq . 3$$

Thus, the sinogram computation is preferably arranged such that all polymerizing voxels (2) move rapidly towards the origin, while those of non-polymerizing voxels (3) move slowly towards an alternative stationary state (4).

Thus, in a first aspect, the present disclosure relates to a method of fabricating a three dimensional object.

The method typically involves a step of computing a number of primary projections. Said primary projections may describe the three-dimensional object to be formed from different orientation angles of said object. The primary projections typically comprise positive and negative intensity values.

The method may comprise a step of deriving, from each primary projection, a positive projection, corresponding to the positive intensity values, and a negative projection, corresponding to the negative intensity values. The positive projection and/or the negative projection are preferably one or more sinograms. Typically, the positive projection is a sinogram comprising all positive values, and the negative projection is a sinogram comprising all negative values, of the original primary projections and/or sinogram(s).

The method may further involve a step of irradiating the build volume at the respective corresponding orientations with light of the first wavelength in a first series of patterns of light, as defined by the negative projections; and light of the second wavelength in a second series of patterns of light, as defined by the positive projections.

In one example, the step of irradiating may comprise irradiating the build volume at the different orientation angles with primary projections, such that: light of the first wavelength in a first series of patterns of light is defined by the negative projections; and light of the second wavelength in a second series of patterns of light is defined by the positive projections.

It is a preference that the build volume is irradiated with light of the first wavelength, in the first series of patterns of light and at the respective corresponding orientations, such that a first energy distribution is provided to the build volume, wherein the energy provided to unpolymerizing voxels is higher than the energy provided to polymerizing voxels; and wherein the polymerizing voxels are voxels of the build volume that are to polymerize or remain unpolymerized in order to accurately reproduce the three-dimensional object, and the unpolymerizing voxels are voxels of the build volume that are to remain unpolymerized in order to accurately reproduce the three-dimensional object.

Alternatively or additionally, it is a preference that the build volume is irradiated with light of the second wavelength, in the second series of patterns of light and at the respective corresponding orientations, such that a second energy distribution is provided to the build volume, wherein the energy provided to polymerizing voxels is higher than the energy provided to unpolymerizing voxels; and wherein the polymerizing voxels and the unpolymerizing voxels are voxels of the build volume that are to polymerize and remain unpolymerized, respectively, in order to accurately reproduce the three-dimensional object.

Preferably, the method is arranged such that the first energy distribution is arranged to provide an energy contrast between unpolymerizing voxels and polymerizing voxels of at least 1.5, more preferably at least 2, even more preferably at least 5, most preferably at least 10.

Typically, the first energy distribution is arranged such that a higher energy is provided to unpolymerizing voxels adjacent to polymerizing voxels than unpolymerizing voxels adjacent to other unpolymerizing voxels.

It is a preference that the primary projection, the negative projections and/or the positive projections are sinograms.

It is a further preference that the primary projection is a sinogram that comprise positive and negative values, and that the positive projection and the negative projection is derived from said primary projection such that the positive projection comprise the positive intensity values, and the negative projection comprise the negative intensity values of said primary projection.

In addition, the method may involve the use of a build volume, which is used to form the three-dimensional object, upon irradiation of said build volume. The build may comprise:
a monomer; and/or
a precursor of a stable radical scavenger; wherein the stable radical scavenger is inducible by light of a first wavelength and wherein the stable radical scavenger is sensitive to light of a second wavelength; and/or
a photosensitive component capable of initiating polymerization of the monomer upon receiving light of the second wavelength.

Thus, the precursor of the stable radical scavenger is typically arranged to be sensitive by light of the first wavelength. The precursor may be arranged such that it, upon receiving light of the first wavelength, generates the stable radical scavenger. The precursor may for example be arranged such that it transforms into the stable radical scavenger upon receiving light of the first wavelength, for example the precursor may be arranged to transform, e.g. by a photolytic reaction, into the stable radical scavenger. Preferably, the stable radical scavenger is inducible by photolysis of the precursor, by light of the first wavelength

Preferably, the stable radical scavenger is arranged to prevent polymerization, i.e. polymerization of the voxel comprising said stable radical scavenger. Typically, the stable radical scavenger is arranged to absorb light of the second wavelength. Thus, by absorbing light of the second wavelength, the stable radical scavenger may prevent polymerization. Preferably, the stable radical scavenger is arranged such that light of the second wavelength consumes the stable radical scavenger, for example the stable radical scavenger may be broken down by photolysis. Thus, the concentration of the stable radical scavenger may be controlled through the energy distribution of light of the first and/or the second wavelength.

In one example, the stable radical scavenger may be formed at a voxel by providing light of the first wavelength to said voxel. This may lead to the precursor of the stable radical scavenger forming said stable radical scavenger. An increased amount of light of the first wavelength provided to the voxel typically leads to an increased concentration of the stable radical scavenger of that voxel

Similarly, by providing light of the second wavelength to a voxel, a stable radical scavenger may be removed from said voxel, for example by a photolytic event, i.e. the concentration of the stable radical scavenger decreases. The photolytic event may for example act to cleave and/or decompose the stable radical scavenger. The stable radical scavenger depends on the build volume/resin, i.e. the photopolymerization system. The stable radical scavenger may for example be bis[2-(o-chlorophenyl)-4,5-diphenylimidazole] (o-Cl-HABI). This molecule generates two lophyl radicals upon photolysis, and the capacity of creating photochemical negativity scales with its concentration ([o-Cl-HABI]) stoichiometrically.

In contrast to photoinhibitors used in more conventional light-based additive manufacturing methods, a stable radical scavenger is favored in a system designed for tomographic printing because of its cumulative nature.

In one embodiment of the present disclosure the rate of polymerization is a function of the ratio between the intensity of the light of the first wavelength and the light of the second wavelength. As light having the first wavelength may be used to suppress polymerization of voxels irradiated by said light, i.e. voxels that absorb said light, the polymerization of these voxels may be controlled through selecting the provided dose of light having the first and the second wavelength.

Controlling the light of the first and the second wavelength typically involves also controlling the temporal delivery of the light dose, based on a nonlinear photoresponse of the components of the build volume. Thus, it may be advantageous to ensure that voxels of the build volume that is to remain unpolymerized (i.e. to remain as liquid voxels) continuously during the curing process has a component that act to suppress polymerization, typically by having a non-zero concentration of the stable radical scavenger. Typically, the energy distribution of the light of the first wavelength is such that voxels that are to remain unpolymerized (liquid voxels) that are adjacent and/or near voxels that are to become polymerized (solid voxels) in order to accurately reproduce the three-dimensional object, receives a higher dose of said light having a first wavelength in comparison with a liquid voxel.

In one embodiment of the present disclosure, the build volume may comprise a secondary radical scavenger. The secondary radical scavenger is typically a chemical compound that is arranged to prevent polymerization of the build volume, e.g. the monomer. The secondary radical scavenger may be sensitive to light of the secondary wavelength, for example the secondary radical scavenger may be arranged to absorb light of the secondary wavelength. In this way the secondary radical scavenger may be said to compete with the photoinitiator for the light of the second wavelength. The secondary radical scavenger may be arranged to prevent polymerization by absorbing light of the second wavelength.

The secondary radical scavenger may be uniformly distributed in the build volume, and/or may in specific examples the build volume may be provided with the secondary radical scavenger. Typically, the secondary radical scavenger is stable without illumination (e.g., oxygen in free radical polymerization). Thus, in one embodiment of the present disclosure, a secondary radical scavenger is selected from the list including oxygen and/or 2,2,6,6-tetramethylpiperdinoxyl.

Preferably, the stable radical scavenger is selected such that it is stable for a long time, preferably during the entire time during which the build volume is illuminated with light having the secondary wavelength. Typically, the stable radical scavenger is stable for at least 1 s, more preferably at least 3 s, even more preferably at least 5 s, most preferably at least 10 s, most preferably the stable radical scavenger is stable in the absence of light of the secondary wavelength.

A skilled person is familiar with various setups for performing tomographic vat photopolymerization. Light is may for example be provided from one or more fixed light sources (e.g. projectors), while the build volume is rotated in order to receive light from said light sources from multiple angles. Typically, the build volume is provided in a cylinder beaker placed within an outer container, for example rectangular, comprising an index-matched liquid. The build volume may for example be provided in a cylinder beaker placed within a rectangular outer container comprising the index-matched liquid. However, in other examples the build volume is made to be stationary while the one or more light sources are arranged to revolve around a central vertical axis of the build volume, in order to provide light onto the build volume from multiple angles. In other examples there may be multiple light sources providing light from different angles, typically in the same plane as the plane of rotation of the build volume. However, one or more light sources may be provided in other planes. Typically, the relative rotation between the build volume and the irradiation(s)/light source(s), is at least 180 degrees. Thus, in cases where the light source(s) are stationary, the build volume must at least rotate 180 degrees. Alternatively, the build volume may be stationary and the light source(s) may be arranged to rotate at least 180 degrees around the build volume, such as wherein the build volume is irradiated with light from a sector of 180 degrees. However, as mentioned above, the build volume may be arranged to rotate while the light source is moved with respect to the build volume, thus in such instances, one may refer to the relative rotation, which is typically at least 180 degrees, i.e. the build volume is irradiated from a sector of 180 degrees. However, the sector may be at least 360 degrees, or even more. Preferably, the sector is at least 360 degrees, for example at least 720 degrees, or even 1080 degrees. The sector may for example be between 360 degrees and 3600 degrees.

The system may for example be arranged such that it illuminates the build volume with light of the first and the second wavelength simultaneously. The light with the first and the second wavelength may for example be merged by a dichroic mirror, for example such that they are provided to the build volume from the same angle.

In TVP, the light dose provided to the voxels of the build volume is built up gradually, such that the polymerizing voxels, i.e. those that should be solid, polymerize substantially at the same time. This is typically in contrast to other additive manufacturing (AM) methods wherein the voxels polymerize continuously in order to manufacture a three-dimensional object, for example layer-by-layer approaches wherein planes are polymerized individually. In TVP, polymerization of a voxel typically requires receiving, by said voxel, a light dose that is the result of irradiation of a series of patterns of light from a plurality of orientation angles. For example, polymerization may occur after receiving light from a larger part of the illumination sector, such as 180 degrees of the sector. Thus, polymerization is typically the result of a three-dimensional energy distribution, and not the dosage distribution provided to a single plane, such as before providing a dosage distribution to another plane.

However, preferentially, the build volume is illuminated simultaneously by light having the first wavelength and light having the second wavelength. Preferably, the build volume is illuminated with light having the first wavelength following completion of the illumination of the light having the second wavelength. As the light having the second wavelength may lead to an initiator of reactive species in the build volume (e.g. radicals), by continuing the illumination of the build volume by light having the first wavelength after ceasing the illumination of the build volume by light having the second wavelength, polymerization of voxels that are to remain unpolymerized (e.g. liquid voxels) may be prevented, and the printing accuracy may be increased.

Typically, the build volume is provided with light of the first wavelength and light of the second wavelength at the respective orientations as defined by the negative and positive projections. Typically, the build volume is provided with light of the first wavelength in the first series of patterns of light, as defined by the negative projections; and light of the second wavelength in the second series of patterns of light, as defined by the positive projections.

A person skilled in the art is familiar with many different systems for photopolymerization of a build volume. I.e. many different components of a build volume that may be used for photopolymerization.

Commonly, systems for photopolymerization relies on free-radical polymerization (FRP) which is a method of polymerization by which a polymer forms by the successive addition of free-radical building blocks. Free radicals can be formed by a number of different mechanisms, usually involving separate initiator molecules. Following its generation, the initiating free radical adds (nonradical) monomer units, thereby growing the polymer chain. The build volume may for example comprise an acrylate, epoxy or vinyl monomer, which is to be polymerized. A skilled person is familiar with various photoinitiators, and that they are sensitive to light of different wavelengths.

Typically, one of the first and second wavelengths is in the UV range, with a wavelength range from 10 nm to 400 nm, and wherein the other of said wavelengths is in the visible light range with a wavelength range from 400 nm to 700 nm. For example, the first wavelength may be in the range of 365 nm and 385 nm, while the second wavelength may be in the range of between 400 nm and 500 nm. Alternatively, the first wavelength may be in the range of from 400 nm to 500 nm while the second wavelength may be in the range of from 365 nm to 385 nm.

The stable radical scavenger may be selected based on the photochemical system used. However, as discussed elsewhere herein the stable radical scavenger is typically inducible by light of the first wavelength and sensitive to light of the second wavelength. Thus, the stable radical scavenger may be arranged to absorb light of the second wavelength, for example in order to prevent a photoinitiator from being activated.

In one embodiment of the present disclosure, the stable radical scavenger is selected from the list including lophyl radical and/or tetraethylthiuram disulfide.

Similarly, various monomers are known to be suitable for different photochemical polymerization systems. In one example, the monomer is selected from the group including TEGDMA and/or bisGMA.

The photoinitiator may be selected from the group including camphorquinone and/or ethyl 4-(dimethylamino)benzoate. Ethyl 4-(dimethylamino)benzoate (Et-PABA) is a hydrophilic polymer, which can also be used as a derivative of 4-aminobenzoate.

Camphorquinone, also known as 2,3-bornanedione is a photoinitiator that in general induces polymerization slowly, so amines such as N,N-dimethyl-p-toluidine, 2-ethyl-dimethylbenzoate, N-phenylglycine are typically added to increase the rate of curing. It absorbs very weakly at 468 nm giving it a pale yellow color.

In a further aspect, the present disclosure relates to a system for fabricating a three-dimensional object from a build volume. The system typically comprises a processing unit and/or a memory. The system and/or the memory typically comprises a computer program that comprises instructions which, when the program is executed (e.g. by the system or a computer), cause the program to compute a number of primary projections describing the three-dimensional object to be formed from different orientation angles of said object; and wherein the primary projections comprise positive and negative intensity values. The system may in this way be configured to derive, from each primary projection, a positive projection, corresponding to the positive intensity values, and a negative projection, corresponding to the negative intensity values.

Typically, the positive projections may be provided as, or used to form, a positive sinogram. Similarly, the negative projections may be provided as, or used to form, a negative sinogram. Typically, addition (e.g. pixel-per-pixel addition

The system typically further comprises a projection system configured for irradiating the build volume at the respective corresponding orientations. The projection system may comprise one or more light sources, e.g. projectors. The light sources may be located in the same plane as the plane of rotation of the build volume. Alternatively, the light sources may be in one or more planes. In other examples, the light sources revolve around the build volume.

In a preferred embodiment of the present disclosure, the system comprises a processor adapted to perform the method of fabricating a three-dimensional object as disclosed elsewhere herein.

The system may comprise a build volume comprising a monomer; a precursor of a stable radical scavenger; wherein the stable radical scavenger is inducible by light of the first wavelength and wherein said stable radical scavenger is sensitive to light of the second wavelength; and a photosensitive component capable of initiating polymerization of the monomer upon receiving light of the second wavelength. The monomer, the precursor and/or the stable radical scavenger may be configured as disclosed elsewhere herein, i.e. in order to carry out the method as disclosed elsewhere herein. As such, the precursor may be bis[2-(o-chlorophenyl)-4,5-diphenylimidazole] (o-Cl-HABI), and/or arranged to generate two lophyl radicals upon photolysis, and arranged such that the capacity of creating photochemical negativity scales with its concentration ([o-Cl-HABI]) stoichiometrically.

In one embodiment of the present disclosure, the system is arranged to irradiate the build volume with light of the first wavelength, in the first series of patterns of light and at the respective corresponding orientations, such that a first energy distribution is provided to the build volume, wherein the energy provided to unpolymerizing voxels is higher than the energy provided to polymerizing voxels; and wherein the polymerizing voxels and the unpolymerizing voxels are voxels of the build volume that are to polymerize or remain unpolymerized in order to accurately reproduce the three-dimensional object.

In one embodiment of the present disclosure, the first energy distribution is arranged to provide an energy contrast between unpolymerizing voxels and polymerizing voxels of at least 1.5, more preferably at least 2, even more preferably at least 5, most preferably at least 10.

In one embodiment of the present disclosure, the first energy distribution is arranged to provide a higher energy to unpolymerizing voxels adjacent to polymerizing voxels than unpolymerizing voxels adjacent to other unpolymerizing voxels.

In one embodiment of the present disclosure, the primary projection, the negative projections and/or the positive projections are sinograms.

In one embodiment of the present disclosure, the positive projection comprises the positive pixel values and the negative projection comprises the negative pixel values of each corresponding primary projection.

In one embodiment of the present disclosure, each primary projection comprises the intensity values of the corresponding positive and negative projections.

In one embodiment of the present disclosure, the build volume is illuminated simultaneously, at the respective corresponding orientations, with:
light of the first wavelength in the first series of patterns of light, as defined by the negative projections; and
light of the second wavelength in the second series of patterns of light, as defined by the positive projections.

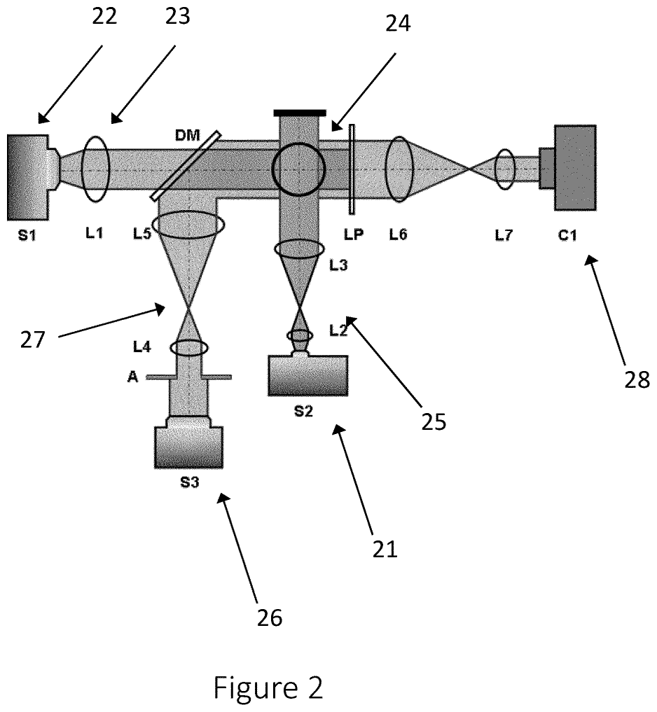

For example, the method disclosed herein may be carried out by the use of a system for dual color tomographic volumetric printing (DCTVP), FIG. 2. Such a system may comprise means for visualization of the polymerization process, simultaneously as the polymerization occurs. The means for visualization may comprise a visible light source and a camera. In any event, the system typically comprises at least one light source, preferably two light sources. As shown in FIG. 2, the light sources may be one or more projectors. Preferably, one light source is an UV light source (21) while the other is a visible light source (22). The UV and visible light paths may be built orthogonally and the illumination for in situ imaging may be merged into the visible light path via a dichroic mirror, which for example may let through visible light under a specific wavelength, such as 490 nm, from the visible light course and reflect longer, typically in case the system comprise a visualization means.

The visible light source (22) may for example be a DLP projector. The visible light source may be used together with an optical lens (23, e.g. f=200 mm), to project visible light into the curing volume (24). The UV light source (21) may be a UV DMD projector. The UV light source may be focused through a 4f-lens system (25, e.g. L2: f=200 mm & L3: f=300 mm), on the Fourier plane of which an aperture was used to block unwanted diffraction orders from the DMD and to improve intensity homogeneity. Two projecting centerlines are typically aligned to intersect at the rotation axis of the curing volume. An imaging light source may be used, for example an LED source. The imaging light source may be collimated through two 4f lens systems (27) and used as a visualization means together with the camera (28).

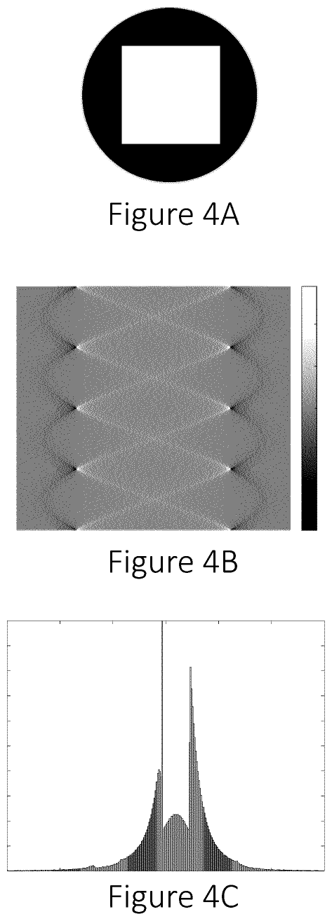

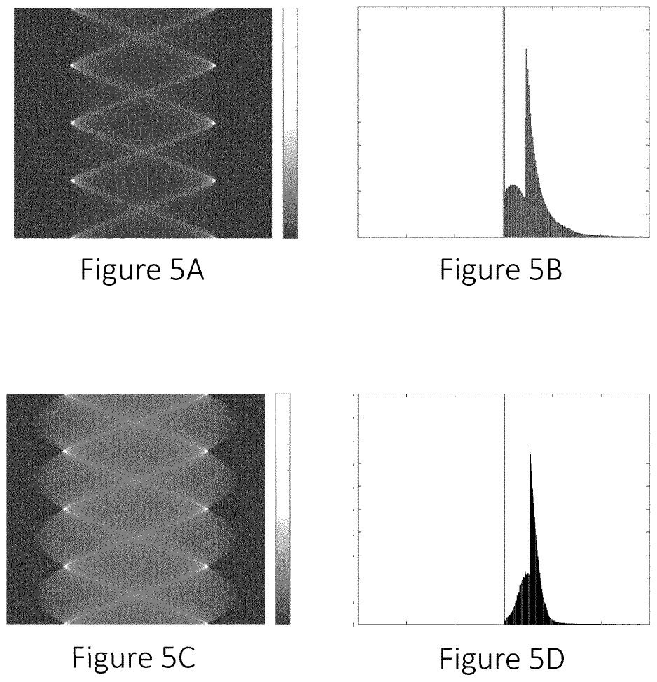

FIG. 4 shows the impact of non-negativity constraints (NNC). A square and its sinogram and histogram is computed using the iterative method and shown in FIG. 4A-C. As shown in the histogram (FIG. 4C), the sinogram (FIG. 4B) contains negative intensity values that erase undesired energy build-up. (B) Two methods of handling negativity in single color printing are: 1, setting all negativities to zero (FIG. 5A); 2, non-negativity constraints applied in each iteration during sinogram computation (FIG. 5B).

### Example 1: Removing Non-Negativity Constraints in Tomographic Volumetric Printing by the Use of a Radical Stable Scavenger

### Materials and Methods

A cylindrical test tube (Ø12.4 mm) containing photoresin was mounted to a motorized rotation stage (PRM1/MZ8, Thorlabs) located at the intersection of the two light paths, as shown in FIG. 1. A cuboid vat containing index-matching fluid was placed outside the test tube, with walls perpendicular to incident beams.

A methacrylate based photoresin was prepared by mixing triethylene glycol dimethacrylate (TEGDMA, CAS #109-16-0, Sigma-Aldrich) and bisphenol A glycerolate dimethacrylate (bisGMA, CAS #1565-94-2, Sigma-Aldrich) at a weight ratio of 1:1, adding 0.2 wt % camphorquinone (CQ, CAS #10373-78-1, ≥96.5% purity, Sigma-Aldrich) and 0.5 wt % ethyl 4-dimethylaminobenzoate (EDAB, CAS #10287-53-3, Sigma-Aldrich) as the photoinitiator and co-initiator, respectively. 2,2′-Bis(2chlorophenyl)-4,4′,5,5′-tetraphenyl-1,2′-biimidazole (o-CI-HABI, CAS #7189-82-4, TCI Europe) was first dissolved in tetrahydrofuran (THF, CAS #109-99-9, Fisher Scientific) at 28 wt % then added to the photoresins at 1 wt %. As disclosed herein, other concentrations (e.g. 3 wt %) are possible.

### Resin Response Calibration

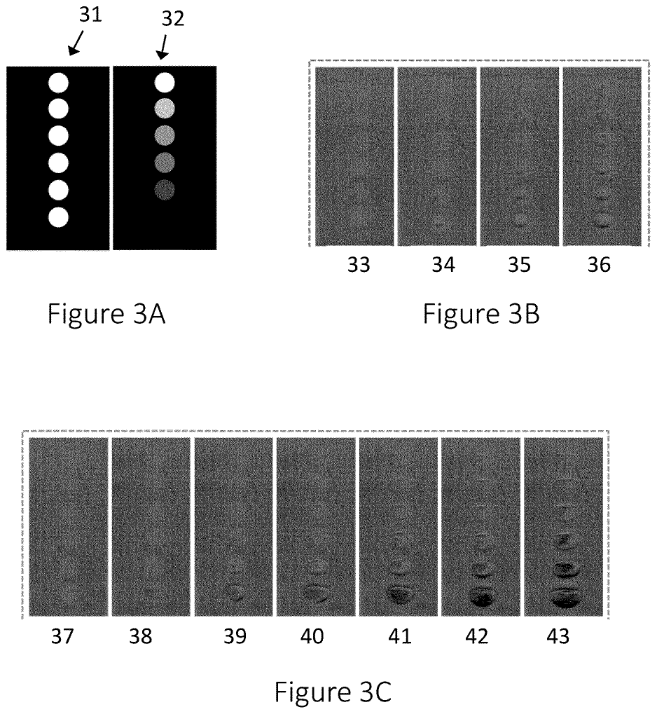

Irradiance was measured as a function of grayscale intensity for both light sources. Ball series at the rotation center (FIG. 3A) were then printed at various UV intensities for photoresponse calibration. Six filled circles (Ø3 mm) were projected by the visible light source (31) at maximum intensity (grayscale 255) and by the UV light source (32) at incremental intensities from 0 to 255. Rotation period was set to 24 s. FIG. 3B shows the single color mode (e.g. only the visible light source) at t=0 (33), t=37s (34), t=40s (35), t=43s (36), and FIG. 3C shows the dual color mode (e.g. visible and UV light sources) at t=0s (37). t=37s (38), t=43s (39), t=49s (40), t=53s (41), t=57s (42), t=62s (43), The delay in the appearance of workpieces reflected the efficiency of negativity generation as a function of UV irradiance.

Visible intensity was set to 255 for all 6 filled circles. UV intensities were (from top to bottom) 255, 205, 155, 105, 55 and 0. Single color printing (FIG. 3B), workpieces appeared after 37 s. Dual color printing (FIG. 3C), all workpieces appeared by 62 s, suggesting W≤0.68 at the rotation center.

### Sinogram Computation

Sinogram computation relied on iterative sinogram computation. An STL file was sliced using ChiTuBox (CBD-Tech, SZX) and the gray values of the pixels in the resulting TIFF stack were adjusted in accordance with desired target dose distribution. The primary projection was a sinogram which was computed using naïve forward projection, i.e. for each projecting angle θ, the position D(d) of the projection of point P(x,y) on a 1D detector was determined by

d=y cos θ−x sin θ

and the gray value of P was added to the light intensity at D. The initial sinogram thus generated was back-projected to estimate reconstruction quality. We used a logistic equation to simulate the nonlinear response of free radical polymerization to energy build-up. The critical incident dose was estimated according to tests presented in FIG. 3, showing the photoresponse of Resin M-1. (FIG. 3A-C)

The workpiece was then compared with the original design and the difference was forward projected to generate a correction for the primary projections (i.e. the previous sinogram) in order to result in an updated primary projection (sinogram).

The correction may result in negativities. If these negativities are kept until the last iteration and then set to zero, the resulting projections (sinograms and projections) would be as shown in FIG. 5A-B.

If they are set to zero in each iteration, the resulting projections (sinograms and projections) would be as shown in FIG. 5C-D. This method of negativity removal prevents the sinogram from fully reconstructing the desired geometry, and thus the heuristic thresholding became essential in generating sinograms for satisfactory print quality.

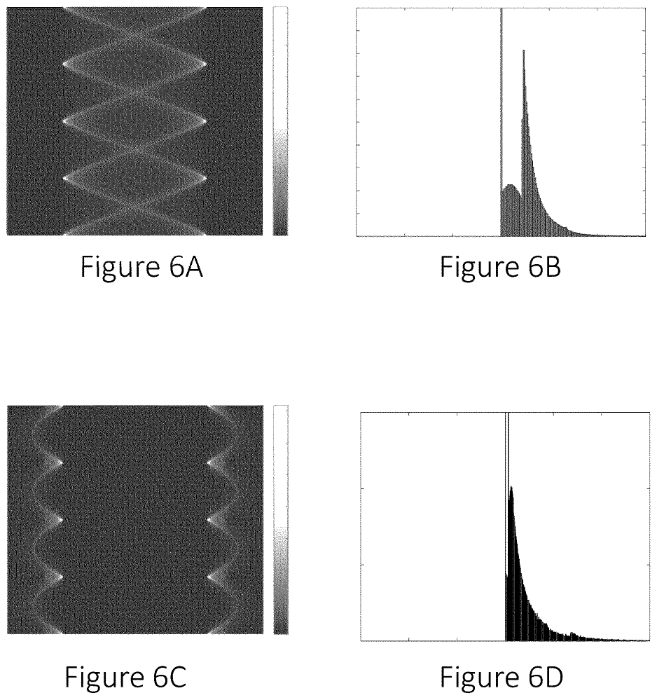

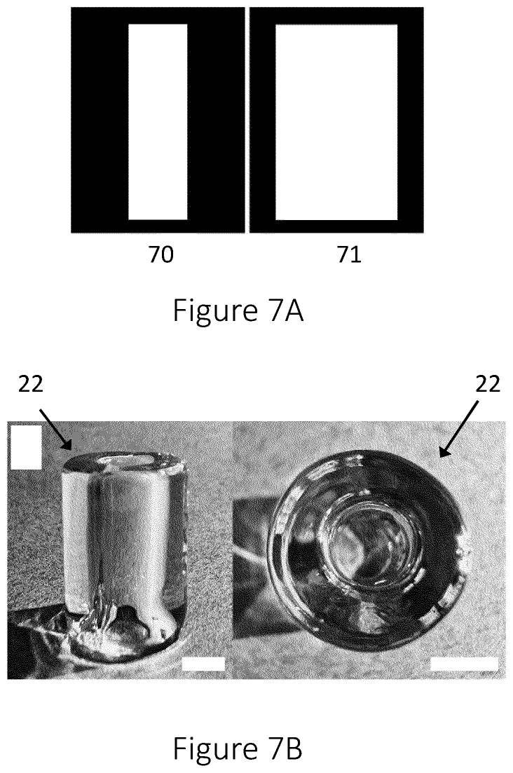

If the negativities are left untreated, the resulting sinogram can be divided according to the signs and be used directly in a dual color, binary photoinhibitory system, as shown in FIG. 6B (visible light ~455 nm) and FIG. 6D (UV light ~365 nm), together with their respective sinogram (FIG. 6A and FIG. 6B). In this way, positive projections and negative projections were formed in the present example using two rectangular shapes as shown in FIG. 7A-B.

In general, the goal is to minimize the number of error voxels, which are either intended solid voxels that do not receive sufficient light dose and thus remain unpolymerized (negative error voxels, or NEVs) or voxels that should have remained unpolymerized but are over-dosed to solidify (PEVs). With non-negativity constraints (NNC), the printing time is determined by the minimum number of full rotations required to eliminate NEVs, and print quality declines with increasing number of PEVs generated during these rotations. Setting negativities to zero (e.g. as in FIG. 5A-B) would typically amount to purposely turning voxels most susceptible to over-exposure (e.g., corners of the square) into PEVs, and thus limiting the achievable print accuracy. Yet, if the NNC is accounted for during iterative sinogram computation, the extra doses for most susceptible voxels are typically dispensed among the entire curing volume, i.e., the high tendency of a few voxels to become PEVs is reduced at the expense of tolerating undesired dose build-up in many other voxels. As a result, the calculated projections offer high accuracy, but the print quality declines quickly due to the soaring of PEVs once the optimal termination point is missed. Removing the NNC significantly prolongs the process window without compromising accuracy. The original sinogram was divided into two parts according to the signs of pixel intensity. The positive pixels were projected by the visible source and the negative ones by UV. The information carried by the negativities was thus preserved by taking the absolute value of corresponding pixels, converting them to positive, grayscale UV patterns. Because UV stabilizes voxels at an unpolymerized stationary state (SS), the increase of PEVs can be arrested after all NEVs are eliminated. Before NEVs disappeared completely, the shape of a workpiece was sensitive to the rotation period. With a rotation period of 24 s this sensitivity persisted for the first three full rotations in our tests.

### Illumination

The resin (M-1) was illuminated for 48 s with visible light and 54 s for UV light, during a rotation period of 24 s. In order to form a tube, two rectangular shapes were used, with the positive projection as defined by the visible pattern (71). At the same time, the negative projection was defined by the UV light pattern (70), being narrower to prevent polymerization of the inner part of the tube (22, FIG. 7B).

### Result and Conclusion

The three-dimensional object, the tube, was successfully reproduced with an inner part that was unpolymerized. The non-negativity constraint of tomographic volumetric printing has been overcome by the use of a radical stable scavenger.

With NNC, SC mode could not prevent over-exposure at the four corners. Without NNC, DCTVP not only produced more accurate workpieces, but managed to keep improving print quality after three full rotations.

### Items

1. A method of fabricating a three-dimensional object comprising the steps of:
   computing a number of primary projections describing the three-dimensional object to be formed from different orientation angles of said object; and wherein the primary projections comprise positive and negative intensity values;
   deriving, from each primary projection, a positive projection, corresponding to the positive intensity values, and a negative projection, corresponding to the negative intensity values;
   providing a build volume comprising:
      a monomer;
      a precursor of a stable radical scavenger; wherein the stable radical scavenger is inducible by light of a first wavelength and wherein said stable radical scavenger is sensitive to light of a second wavelength; and
      a photosensitive component capable of initiating polymerization of the monomer upon receiving light of the second wavelength; and
   irradiating the build volume at the respective corresponding orientations with:
      light of the first wavelength in a first series of patterns of light, as defined by the negative projections; and
      light of the second wavelength in a second series of patterns of light, as defined by the positive projections.
2. The method according to item 1, wherein the build volume is irradiated with light of the first wavelength, in the first series of patterns of light and at the respective corresponding orientations, such that a first energy distribution is provided to the build volume, wherein the energy provided to unpolymerizing voxels is higher than the energy provided to polymerizing voxels; and wherein the polymerizing voxels and the unpolymerizing voxels are voxels of the build volume that are to polymerize and remain unpolymerized, respectively, in order to accurately reproduce the three-dimensional object.
3. The method according to item 2, wherein the first energy distribution is arranged such that an energy contrast between unpolymerizing voxels and polymerizing voxels of at least 1.5, more preferably at least 2, even more preferably at least 5, most preferably at least 10, is provided.
4. The method according to any one of items 2-3, wherein the first energy distribution is arranged such that a higher energy is provided to unpolymerizing voxels adjacent to polymerizing voxels than unpolymerizing voxels adjacent to other unpolymerizing voxels.
5. The method according to any one of the preceding items, wherein the primary projection, the negative projections and/or the positive projections are sinograms.
6. The method according to any one of the preceding items, wherein the positive projection comprises the positive pixel values and the negative projection comprises the negative pixel values, of each corresponding primary projection.
7. The method according to any one of the preceding items, wherein each primary projection comprises the intensity values of the corresponding positive and negative projections.
8. The method according to any one of the preceding items, wherein the stable radical scavenger is inducible by photolysis of the precursor, by light of the first wavelength.
9. The method according to any one of the preceding items, wherein the stable radical scavenger absorbs light of the second wavelength.
10. The method according to any one of the preceding items, wherein the concentration of the stable radical scavenger is decreased by providing light of the second wavelength.
11. The method according to any one of the preceding items, wherein the polymerization of voxels is suppressed and/or prevented by irradiating said voxels with light of the first wavelength.
12. The method according to any one of the preceding items, wherein the rate of polymerization is a function of the ratio between the intensity of the light of the first wavelength and the light of the second wavelength.
13. The method according to any one of the preceding items, wherein the stable radical scavenger acts to suppress and/or prevent polymerization of the monomer.
14. The method according to any one of the preceding items, wherein the build volume comprises a secondary radical scavenger that is sensitive to light of the second wavelength.
15. The method according to item 14, wherein the secondary radical scavenger is configured to absorb light of the second wavelength.
16. The method according to any one of items 14-15, wherein the secondary radical scavenger is arranged to suppress and/or prevent polymerization of the monomer.
17. The method according to any one of the preceding items, wherein the stable radical scavenger is configured such that it is stable in the build volume for at least 1 s, more preferably at least 3 s, even more preferably at least 5 s, most preferably at least 10 s, in the absence of light of the secondary wavelength.
18. The method according to any one of the preceding items, wherein the build volume is illuminated simultaneously, at the respective corresponding orientations, with:
   light of the first wavelength in the first series of patterns of light, as defined by the negative projections; and
   light of the second wavelength in the second series of patterns of light, as defined by the positive projections.
19. The method according to any one of the preceding items, wherein one of the first and second wavelengths is in the UV range, with a wavelength range from 10 nm to 400 nm, and wherein the other of said wavelengths is in the visible light range with a wavelength range from 400 nm to 700 nm.
20. The method according to any one of the preceding items, wherein the precursor of the stable radical scavenger is o-Cl-HABI.
21. The method according to any one of the preceding items, wherein the stable radical scavenger is selected from the group including lophyl radical and/or tetraethylthiuram disulfide.
22. The method according to any one of the preceding items, wherein the secondary radical scavenger is selected from the list including oxygen and/or 2,2,6,6-tetramethylpiperdinoxyl.
23. The method according to any one of the preceding items, wherein the monomer is selected from the group including TEGDMA and/or bisGMA.
24. The method according to any one of the preceding items, wherein the build volume comprises a photoinitiator selected from the group including camphorquinone and/or ethyl 4-(dimethylamino)benzoate.
25. A system for fabricating a three-dimensional object from a build volume, the system comprising:
   a processing unit configured for:
      computing a number of primary projections describing the three-dimensional object to be formed from different orientation angles of said object; and wherein the primary projections comprise positive and negative intensity values;
      deriving, from each primary projection, a positive projection, corresponding to the positive intensity values, and a negative projection, corresponding to the negative intensity values;
   a projection system configured for:
      irradiating the build volume at the respective corresponding orientations with:
         light of a first wavelength in a first series of patterns of light, as defined by the negative projections; and
         (preferably simultaneously) light of a second wavelength in a second series of patterns of light, as defined by the positive projections.
26. The system according to item 25, wherein the system is arranged to carry out the method of any one of items 1-24.
27. The system according to any one of items 25-26, wherein the system comprises a build volume comprising:
   a monomer;
   a precursor of a stable radical scavenger; wherein the stable radical scavenger is inducible by light of the first wavelength and wherein said stable radical scavenger is sensitive to light of the second wavelength; and
   a photosensitive component capable of initiating polymerization of the monomer upon receiving light of the second wavelength.
28. The system according to any one of items 25-27, wherein the system is arranged to irradiate the build volume such that the energy of the light of the first wavelength provided to unpolymerizing voxels is higher than the energy provided to polymerizing voxels; and/or
   such that the energy of the light of the second wavelength provided to polymerizing voxels is higher than the energy provided to unpolymerizing voxels.
29. The system according to any one of items 25-28, wherein the first energy distribution is arranged to provide an energy contrast between unpolymerizing voxels and polymerizing voxels of at least 1.5, more preferably at least 2, even more preferably at least 5, most preferably at least 10.
30. The system according to any one of items 25-29, wherein the first energy distribution is arranged to provide a higher energy to unpolymerizing voxels adjacent to polymerizing voxels than unpolymerizing voxels adjacent to other unpolymerizing voxels.
31. The system according to any one of items 25-30, wherein the primary projection, the negative projections and/or the positive projections are sinograms.
32. The system according to any one of items 25-31, wherein the positive projection comprises the positive pixel values and the negative projection comprises the negative pixel values, of each corresponding primary projection.
33. The system according to any one of items 25-32, wherein each primary projection comprises the intensity values of the corresponding positive and negative projections.
34. The system according to any one of items 25-33, wherein the build volume is illuminated simultaneously, at the respective corresponding orientations, with:
   light of the first wavelength in the first series of patterns of light, as defined by the negative projections; and
   light of the second wavelength in the second series of patterns of light, as defined by the positive projections.

1. A method of fabricating a three-dimensional object by tomographic vat photopolymerization, the method comprising the steps of:
computing a number of primary projections describing the three-dimensional object to be formed from different orientation angles of said object; and wherein the primary projections comprise positive and negative intensity values;
deriving, from each primary projection, a positive projection corresponding to the positive intensity values, and a negative projection corresponding to the negative intensity values;
providing a build volume comprising:
a monomer;
a precursor of a stable radical scavenger; wherein the stable radical scavenger is inducible by light of a first wavelength and wherein said stable radical scavenger is sensitive to light of a second wavelength; and
a photosensitive component capable of initiating polymerization of the monomer upon receiving light of the second wavelength; and
irradiating the build volume at the different orientation angles with:
light of the first wavelength in a first series of patterns of light as defined by the negative projections; and
light of the second wavelength in a second series of patterns of light as defined by the positive projections.

2. The method according to any one of the preceding claims, wherein the build volume is irradiated with light of the first wavelength, in the first series of patterns of light and at the respective corresponding orientations, such that a first energy distribution is provided to the build volume, wherein the energy provided to unpolymerizing voxels is higher than the energy provided to polymerizing voxels; and wherein the polymerizing voxels and the unpolymerizing voxels are voxels of the build volume that are to polymerize and remain unpolymerized, respectively, in order to accurately reproduce the three-dimensional object.

3. The method according to claim 3, wherein the first energy distribution is arranged such that an energy contrast between unpolymerizing voxels and polymerizing voxels of at least 1.5, more preferably at least 2, even more preferably at least 5, most preferably at least 10, is provided.

4. The method according to any one of claims 3-4, wherein the first energy distribution is arranged such that a higher energy is provided to unpolymerizing voxels adjacent to polymerizing voxels than unpolymerizing voxels adjacent to other unpolymerizing voxels.

5. The method according to any one of the preceding claims, wherein the primary projection, the negative projections and/or the positive projections are sinograms.

6. The method according to any one of the preceding claims, wherein the positive projection comprises the positive pixel values and the negative projection comprises the negative pixel values, of each corresponding primary projection.

7. The method according to any one of the preceding claims, wherein each primary projection comprises the intensity values of the corresponding positive and negative projections.

8. The method according to any one of the preceding claims, wherein the stable radical scavenger is inducible by photolysis of the precursor, by light of the first wavelength.

9. The method according to any one of the preceding claims, wherein the stable radical scavenger absorbs light of the second wavelength.

10. The method according to any one of the preceding claims, wherein the concentration of the stable radical scavenger is decreased by providing light of the second wavelength.

11. The method according to any one of the preceding claims, wherein the rate of polymerization is a function of the ratio between the intensity of the light of the first wavelength and the light of the second wavelength.

12. The method according to any one of the preceding claims, wherein the build volume comprises a secondary radical scavenger that is sensitive to light of the second wavelength.

13. The method according to claim 12, wherein the secondary radical scavenger is configured to absorb light of the second wavelength.

14. The method according to any one of claims 12-13, wherein the secondary radical scavenger is arranged to suppress and/or prevent polymerization of the monomer.

15. The method according to any one of the preceding claims, wherein the stable radical scavenger is configured such that it is stable in the build volume for at least 1 s, more preferably at least 3 s, even more preferably at least 5 s, most preferably at least 10 s, in the absence of light of the secondary wavelength.

16. The method according to any one of the preceding claims, wherein the build volume is illuminated simultaneously, at the respective corresponding orientations, with:
light of the first wavelength in the first series of patterns of light, as defined by the negative projections; and
light of the second wavelength in the second series of patterns of light, as defined by the positive projections.

17. The method according to any one of the preceding claims, wherein one of the first and second wavelengths is in the UV range, with a wavelength range from 10 nm to 400 nm, and wherein the other of said wavelengths is in the visible light range with a wavelength range from 400 nm to 700 nm.

18. The method according to any one of the preceding claims, wherein the precursor of the stable radical scavenger is o-Cl-HABI.

19. The method according to any one of the preceding claims, wherein the stable radical scavenger is selected from the group including lophyl radical and/or tetraethylthiuram disulfide.

20. The method according to any one of the preceding claims, wherein the secondary radical scavenger is selected from the list including oxygen and/or 2,2,6,6-tetramethylpiperdinoxyl.

21. The method according to any one of the preceding claims, wherein the monomer is selected from the group including TEGDMA and/or bisGMA.

22. The method according to any one of the preceding claims, wherein the build volume comprises a photoinitiator selected from the group including camphorquinone and/or ethyl 4-(dimethylamino)benzoate.

23. A system for fabricating a three-dimensional object from a build volume by tomographic vat photopolymerization, the system comprising:
a processing unit configured for:
computing a number of primary projections describing the three-dimensional object to be formed from different orientation angles of said object; and wherein the primary projections comprise positive and negative intensity values;
deriving, from each primary projection, a positive projection, corresponding to the positive intensity values, and a negative projection, corresponding to the negative intensity values;
a projection system configured for:
irradiating the build volume at the respective corresponding orientations with:
light of a first wavelength in a first series of patterns of light, as defined by the negative projections; and
light of a second wavelength in a second series of patterns of light, as defined by the positive projections.

24. The system according to claim 23, wherein the system is arranged to carry out the method of any one of claims 1-22.

25. The system according to any one of claims 23-24, wherein the system comprises a build volume comprising:
a monomer;
a precursor of a stable radical scavenger; wherein the stable radical scavenger is inducible by light of the first wavelength and wherein said stable radical scavenger is sensitive to light of the second wavelength; and
a photosensitive component capable of initiating polymerization of the monomer upon receiving light of the second wavelength.

26. The system according to any one of claims 23-25, wherein the system is arranged to irradiate the build volume such that the energy of the light of the first wavelength provided to unpolymerizing voxels is higher than the energy provided to polymerizing voxels; and/or
such that the energy of the light of the second wavelength provided to polymerizing voxels is higher than the energy provided to unpolymerizing voxels.

27. The system according to any one of claims 23-26, wherein the first energy distribution is arranged to provide an energy contrast between unpolymerizing voxels and polymerizing voxels of at least 1.5, more preferably at least 2, even more preferably at least 5, most preferably at least 10.

28. The system according to any one of claims 23-27, wherein the first energy distribution is arranged to provide a higher energy to unpolymerizing voxels adjacent to polymerizing voxels than unpolymerizing voxels adjacent to other unpolymerizing voxels.

29. The system according to any one of claims 23-28, wherein the primary projection, the negative projections and/or the positive projections are sinograms.

30. The system according to any one of claims 23-29, wherein the positive projection comprises the positive pixel values and the negative projection comprises the negative pixel values, of each corresponding primary projection.

31. The system according to any one of claims 23-30, wherein each primary projection comprises the intensity values of the corresponding positive and negative projections.

32. The system according to any one of claims 23-31, wherein the build volume is illuminated simultaneously, at the respective corresponding orientations, with:
light of the first wavelength in the first series of patterns of light, as defined by the negative projections; and
light of the second wavelength in the second series of patterns of light, as defined by the positive projections.
